(19) United States
(12) Patent Application Publication
(10) Pub. No.: US 2015/0034183 A1
(43) Pub. Date: Feb. 5, 2015

(54) EXTERNALLY ADJUSTABLE MAGNETIC TARGET SETTING

(71) Applicant: General Equipment and Manufacturing Company, Inc., d/b/a TopWorx, Inc., Louisville, KY (US)

(72) Inventor: Jason S. Jennings, Jeffersonville, IN (US)

(21) Appl. No.: 14/448,775

(22) Filed: Jul. 31, 2014

Related U.S. Application Data
(60) Provisional application No. 61/861,381, filed on Aug. 1, 2013.

(51) Int. Cl. F16K 17/06

(52) U.S. Cl. CPC F16K 17/06
USPC 137/524

(57) ABSTRACT

A valve target assembly includes a longitudinally-extending valve shaft having a first portion coupled to a flow control element. The valve target assembly also includes an enclosure having a plurality of walls cooperating to define a sealed interior portion, and a second portion of the shaft is disposed within the interior portion. A first detection member is disposed with the interior portion of the enclosure. A target support is coupled to a third portion of the valve shaft, and the target support is disposed outside of the interior portion. A first target is coupled to the target support, and in a first shaft position, the first target is adapted to be within a detection range of the first detection member. In a second shaft position, the first target is adapted to be outside of the detection range of the detection member.

### FIELD OF THE DISCLOSURE

This disclosure relates generally to control valves, and, more particularly, to target assemblies that indicate a position of the control valve.

### BACKGROUND

Control valves are used in process control systems to control conditions such as flow, pressure, temperature, and/or liquid level by fully or partially opening or closing in response to a signal received from one or more valve controllers. Typically, a valve controller is operatively coupled to or includes one or more sensors or switches disposed within the system, thereby allowing the valve controller to compare one or more “setpoints” to a corresponding “process variable” whose value is provided by the switches or sensors. The opening or closing of control valves is typically done automatically by electrical, hydraulic, or pneumatic actuators. In addition, positioners may be used to control the opening or closing of the actuator based on, for example, electric or pneumatic signals received from the valve controller.

In typical control valve assemblies, the one or more switches (such as proximity switches) or other sensors of the valve controller are adapted to detect targets (such as magnets) that are coupled to a portion of the valve (e.g., a valve stem) to determine one or more operational parameters of the control valve, such as the position of the closure member of the control valve. More specifically, in control valve assemblies that include a shaft that rotates about its longitudinal axis to open and close the valve (i.e., rotate the valve closure member from a closed position in which the valve closure member engages a valve seat to an open position in which the valve closure member is disengaged from the valve seat), the magnets and switches may both be disposed within an interior of an enclosure of the valve controller. To reposition the magnets relative to the switches, a technician must open the enclosure and manually reposition the magnets on a fixture secured to the shaft. Typically, however, the enclosure is sealed to protect the components from the ambient environment, which may include extreme heat or excessive moisture, for example. Accordingly, closing the enclosure while maintaining the seal is a time consuming and precise process, and a compromise of the seal may result in a total failure of one or more components disposed within the enclosure.

### BRIEF SUMMARY OF THE DISCLOSURE

In accordance with one exemplary aspect of the present invention, a valve target assembly includes a target shaft extending along a target longitudinal axis, the target shaft having a first end and a longitudinally-opposite second end. The first end of the target shaft is adapted to be coupled to a valve shaft that is coupled to a flow control element. The valve target assembly also includes an enclosure having a plurality of walls that cooperate to define a sealed interior portion, and a portion of the target shaft is disposed within the interior portion of the enclosure. A first detection member is disposed with the interior portion of the enclosure. A target support is coupled to the target shaft, and the target support is disposed outside of the interior portion of the enclosure. A first target is coupled to the target support, and in a first shaft position, the first target is adapted to be within a detection range of the first detection member. In a second shaft position that is rotationally offset from the first shaft position, the first target is adapted to be outside of the detection range of the detection member.

In accordance with another exemplary aspect of the present invention, a control valve assembly includes a valve shaft extending along a longitudinal axis, the valve shaft having a first end and a longitudinally-opposite second end, and a flow control element is coupled to a first portion of the valve shaft. The control valve assembly also includes a valve body having an inlet, an outlet, and a valve seat disposed between the inlet and the outlet. A valve actuator is coupled to the valve shaft, and the valve actuator adapted to rotate the valve shaft about the longitudinal axis such that the flow control element rotates from a closed position in which the flow control element sealingly engages the valve seat to an open position in which the flow control element is disengaged from the valve seat. The control valve assembly further includes an enclosure coupled to the valve body, the enclosure having a plurality of walls that cooperate to define a sealed interior portion, and a second portion of the valve shaft is disposed within the interior portion of the enclosure. A first detection member is disposed with the interior portion of the enclosure, and a target support is coupled to a third portion of the valve shaft. The target support is disposed outside of the interior portion of the enclosure, and a first target is coupled to the target support. In a first shaft position, the first target is adapted to be within a detection range of the first detection member. In a second shaft position rotationally offset from the first shaft position, the first target is adapted to be outside of the detection range of the first detection member.

### BRIEF DESCRIPTION OF THE DRAWINGS

FIG. 1 is perspective view of a control valve assembly that includes a control valve, an actuator, and an embodiment of a valve target assembly;

FIG. 2 is a sectional view of the embodiment of the control valve assembly of FIG. 1;

FIG. 3 is a top view of a first detection member;

FIG. 4A is a top view of a target support of the valve target assembly;

FIG. 4B is a side view of the target support of FIG. 4A;

FIG. 5A is a top view of a target within a detection range of a detection member; and

FIG. 5B is a top view of a target outside of the detection range of the detection member of FIG. 5A.

### DETAILED DESCRIPTION

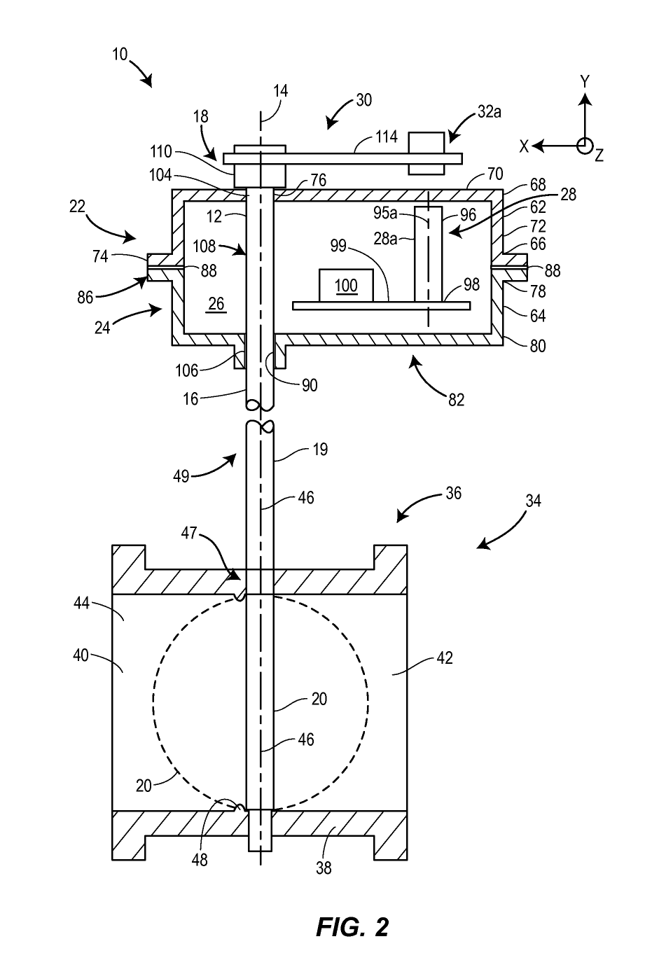

As illustrated in FIG. 2, a valve target assembly 10 includes a target shaft 12 extending along a target longitudinal axis 14, the target shaft 12 having a first end 16 and a longitudinally-opposite second end 18. The first end 16 of the target shaft 12 is adapted to be coupled to a valve shaft 19 that is coupled to a flow control element 20. The valve target assembly 10 also includes an enclosure 22 having a plurality of walls 24 that cooperate to define a sealed interior portion 26, and a portion of the target shaft 12 is disposed within the interior portion 26 of the enclosure 22. A first detection member 28a is disposed with the interior portion 26 of the enclosure 22. A target support 30 is coupled to the target shaft 12, and the target support 30 is disposed outside of the interior portion 26 of the enclosure 22. A first target 32a is coupled to the target support 30, and in a first shaft position, the first target 32a is adapted to be within a detection range 102a of the first detection member 28a, as illustrated in FIG. 5A. In a second shaft position that is rotationally offset from the first shaft position, the first target 32a is adapted to be outside of the detection range 102a of the detection member 28a, as illustrated in FIG. 5B. Because the target support 30 is disposed outside of the interior portion 26 of the enclosure 22, the first target 32a can be repositioned on the target support 30 relative to the first detection member 28a without the need to disassemble the enclosure 22. Accordingly, damage to the seals that results from opening and reclosing the enclosure 22 can be avoided.

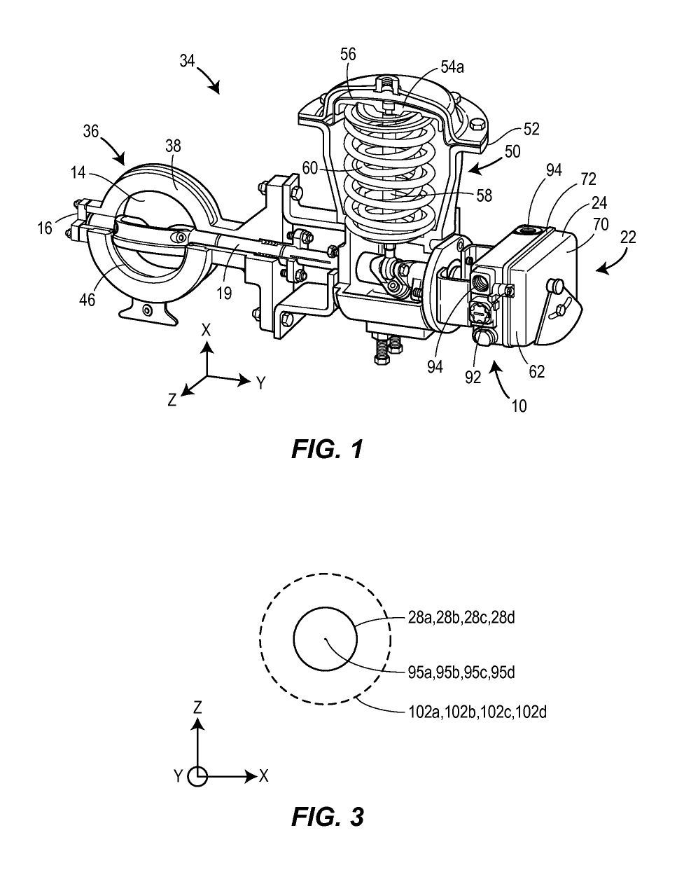

Turning to the valve target assembly 10 in more detail, the valve target assembly 10 may be a component included in a control valve assembly 34, such as that illustrated in FIGS. 1 and 2. The control valve assembly 34 may include a control valve 36, such as a rotary control valve (e.g., a butterfly valve, a control-disk valve, a ball valve, or an eccentric plug valve). The control valve 36 may include a valve body 38 having an inlet 40, an outlet 42, and a passageway 44 between the inlet 40 and the outlet 42. The inlet 40, the outlet 42, and the passageway 44 may each have a circular cross-sectional shape having the same or substantially the same diameter, as illustrated in FIGS. 1 and 2. However, the inlet 40, the outlet 42, and the passageway 44 of the valve body 38 may each have any suitable shape or combination of shapes.

Referring again to FIGS. 1 and 2, the flow control element 20 may be disposed within the passageway 44 and may be coupled to the valve shaft 19 such that a rotation of the valve shaft 19 about a valve longitudinal axis 46 results in a corresponding rotation of the flow control element 20. The valve shaft 19 may extend along the valve longitudinal axis 46 from a first end 47 to a longitudinally-opposite second end 49, and the first end 47 of the valve shaft 19 may be directly or indirectly coupled to the flow control element 20. The valve shaft 19 may be formed as a single, one-piece component, or may be made from two or more segments that are secured to form the valve shaft 19. The valve longitudinal axis 46 may be along or parallel to the Y-axis of the reference coordinate system of FIGS. 1 and 2. A rotational axis of the flow control element 20 may be coaxially aligned with the valve longitudinal axis 46. A valve seat 48 may be disposed along the passageway 44, and the valve shaft 19 may rotate about the valve longitudinal axis 46 such that the flow control element 20 rotates from a closed position (indicated by the solid lines in FIG. 2) in which the flow control element 20 sealingly engages the valve seat 48 to an open position (indicated by the dashed lines in FIG. 2) in which the flow control element 20 is disengaged from the valve seat 46. That is, in the open position, process fluid is capable of following from the inlet 40, through the passageway 44, and to the outlet 42 of the control valve 36. In the closed position, process fluid is prevented from flowing from the inlet 40 to the outlet 42 by the sealing engagement of the flow control element 20 with the valve seat 48. The flow control element 20 may sealingly engage the valve seat 48 in any manner known in the art.

As illustrated in FIG. 1, the control valve assembly 34 may include a valve actuator 50 that is directly or indirectly coupled to the valve shaft 19 to rotate or otherwise displace the flow control element 20 from the closed position to the open position (and vice versa). The valve actuator 50 may be any type of valve actuator known in the art, such as a pneumatic, hydraulic, or electric actuator. Specifically, the valve actuator 50 may include a housing 52 that defines a first chamber 54a and a second chamber 54b that are separated by a diaphragm 56. An actuator rod 58 may couple the diaphragm 56 to the valve shaft 19 such that a longitudinal displacement of the actuator rod 58 may result in a rotation of the valve shaft 19 in a manner known in the art. Pressurized fluid may be introduced into the first chamber 54a of the housing 52 to rotate the flow control element 20 into and out of sealing engagement with the valve seat 48. That is, when pressure in the first chamber 54a is below a critical level, one or more springs 60 disposed in the second chamber 54b of the housing 52 may bias the diaphragm 56 towards a top portion of the housing 52, and thereby rotate the valve shaft 19 such that the flow control element 20 is in the open (or closed) position. However, when pressure in the first chamber 54a is at or above the critical level, the force on the diaphragm 56 may overcome the biasing force of the one or more springs 60 and displace away from the top of the housing 52, and thereby rotate the valve shaft 19 such that the flow control element 20 is in the closed (or open) position.

As illustrated in FIGS. 1 and 2, the valve target assembly 10 includes the enclosure 22 that may be coupled to a portion of the control valve assembly 34. For example, the enclosure 22 may be coupled to the valve actuator 50 as illustrated in FIG. 1. As illustrated in FIG. 2, the enclosure 22 may include the plurality of walls 24 that cooperate to define the sealed interior portion 26. More specifically, the enclosure 22 may be a two-part assembly that includes a hollow lid portion 62 that is sealingly coupled to a hollow base portion 64 to define the sealed interior portion 26. The lid portion 62 may have any suitable shape. For example, the lid portion 62 may have the cross-sectional shape of a square, a rectangle, an oval, a circle, or any combination of cross-sectional shapes. The lid portion 62 may have a first open end 66 and a second closed end 68 opposite the first open end 66. The lid portion 62 may include a top wall 70 disposed at or adjacent to the second closed end 68. The top wall 70 may have any suitable shape or combination of shapes, and the top wall 70 may be a planar and may extend parallel to the X-Z plane of the reference coordinate system of FIGS. 1 and 2. As illustrated in FIG. 2, one or more side walls 72 may extend from each perimeter edge of the top wall 70, and the one or more side walls 72 may extend form the second closed end 68 to the first open end 66. A lid flange 74 may extend along an end portion of each of the one or more side walls 72. A lid bore 76 may extend through the top wall 70, and the lid bore 76 may be dimensioned to receive a portion of the target shaft 12.

Still referring to FIG. 2, the base portion 64 may have any suitable shape, and the shape of the base portion 64 may generally correspond to the shape of lid portion 62. For example, the base portion 64 may have the cross-sectional shape of a square, a rectangle, an oval, a circle, or any combination of cross-sectional shapes. The base portion 64 may have a first open end 78 and a second closed end 80 opposite the first open end 78, and the first open end 78 of the base portion 64 may be coupled to the first open end 66 of the lid portion 62. The base portion 64 may include a bottom wall 82 disposed at or adjacent to the second closed end 80. The bottom wall 82 may have any suitable shape or combination of shapes, and the bottom wall 82 may be a planar and may extend parallel to the X-Z plane of the reference coordinate system of FIGS. 1 and 2. One or more side walls 84 may extend from each perimeter edge of the bottom wall 82, and the one or more side walls 84 may extend form the second closed end 80 to the first open end 78. A base flange 86 may extend along an end portion of each of the one or more side walls 84, and the base flange 86 may mate with the lid flange 74 when the lid portion 62 is coupled to the base portion 64. Any suitable seal (e.g., a gasket 88) may be disposed between the lid flange 74 and the base flange 86 to seal the enclosure 22. A base bore 90 may extend through the bottom wall 82, and the base bore 90 may have an axis that is longitudinally aligned (i.e., aligned along the Y-axis of the reference coordinate system of FIG. 2) with an axis of the lid bore 76 of the lid portion 62. The base bore 90 may be dimensioned to receive a portion of the target shaft 12. The lid portion 62 may be secured to the base portion 64 in any suitable manner, such as by mechanical fastening (e.g., a plurality of bolts 92, as illustrated in FIG. 1). As illustrated in FIG. 1, the base portion 64 and/or the lid portion 62 may have one or more apertures and/or knock-outs 94 that allow for access to the sealed interior portion 26. The base portion 64 and/or the lid portion 62 may be made from any suitable material, such as a non-magnetic material, a non-ferrous material, and/or any material in which a significant magnetic field will not be induced when exposed to an exterior magnetic field (e.g., plastic or aluminum). More specifically, all or part of the top wall 70 of the lid portion 62 may be made of a non-magnetic material, a non-ferrous material, and/or any material in which a significant magnetic field will not be induced when exposed to an exterior magnetic field.

Referring to FIG. 2, the sealed interior portion 26 of the enclosure 22 may include one or more detection members 28 (e.g., a sensor or switch) adapted to cooperate with a first target 32a to determine a relative position of the flow control member 20. For example, a first detection member 28a, such a magnetically-actuated proximity switch, may be disposed with the sealed interior portion 26. The first detection member 28a may extend along a longitudinal axis 95a that is parallel to the Y-axis of the reference coordinate system of FIG. 2, and the first detection member 28a may extend from a first end 96 to a longitudinally opposite second end 98. The second end 98 of the first detection member 28a may be secured within the enclosure 22 in any suitable manner. For example, the second end 98 of the first detection member 28a may be secured to a printed circuit board 99 disposed with the interior portion 26 of the enclosure 22. The first end 96 of the first detection member 28a may be disposed adjacent to the top wall 70 of the lid portion 62 of the enclosure 22. The first detection member 28a may be in communication with a control unit 100, and the control unit 100 may be disposed at any suitable location. For example, the control unit 100 may be disposed within the interior portion 26 of the enclosure 22, as illustrated in FIG. 2. More specifically, the control unit 100 may be communicatively coupled to the first detection member 28a by one or more communication pathways formed on the printed circuit board 99. Alternatively, the control unit 100 may be disposed outside the interior portion 26 of the enclosure 22 and the first detection member 28a may be in communicatively coupled to the control unit 100 in any suitable manner, such as by one or more communication lines (not shown) that may extend through one or more of the apertures or knock-outs 94 of the enclosure 22.

With the first detection member 28a secured within the interior portion 26 of the enclosure 22, an area surrounding the first detection member 28a defines a first detection range 102a, as illustrated in FIG. 3. The first detection range 102a may be defined as an area in which the presence of a target (such as the first target 32a) causes the first detection member 28a to change from a first state to a second state (or vice versa). That is, the first detection member 28a may have internal switching or sensing components that will switch or otherwise change state when the first target 32a moves into or out of the first detection range 102a. The first detection member 28a may be any suitable type of switch, such as a magnetically-triggered proximity switch (such as the magnetically-triggered proximity switches disclosed in U.S. Pat. No. 8,400,241, which is incorporated herein by reference). As an example, the first end 96 of the first detection member 28a may include a dispaceable magnetic element (e.g., an internal element made of a magnetic material or a ferrous material) that may be biased in a first position by a biasing magnet, and this first position may complete a first circuit (i.e., a first state). However, when the first target 32a moves at least partially within the first detection range 102a (as illustrated in FIG. 5A), the magnetic force between the first target 32a and the dispaceable magnetic element may be more powerful than the magnetic force between the dispaceable magnetic element and the biasing magnet. Accordingly, the magnetic element displaces to a second position away from the biasing magnet, thereby breaking the first circuit and completing a second circuit (i.e., a second state). When the first target 32a moves outside of the first detection range 102a (as illustrated in FIG. 5B), the magnetic force between the first target 32a and the dispaceable magnetic element weakens and becomes less powerful than the magnetic force between the dispaceable magnetic element and the biasing magnet, and the dispaceable magnetic element may move to the first position, thereby breaking the second circuit and completing the first circuit. Because the control unit 100 is in communication with the first circuit and the second circuit, the control unit 100 may indicate that a change in state has occurred (i.e., a change from the first state to the second state, or vice versa). In addition, LEDs disposed on the first detection member 28a (e.g., at or adjacent to the first end 96) may indicate whether the first detection member 28a is in the first state or the second state.

Any suitable number of detection members may be disposed within the interior portion 26 of the enclosure 22. For example, a first detection member 28a having a first detection range 102a, a second detection member 28b having a second detection range 102b, a third detection member 28c having a third detection range 102c, and a fourth detection member 28d having a fourth detection range 102d may be disposed within the enclosure 22. Each of the first, second, third, and fourth detection members 28a, 28b, 28c, 28d may be identical, and the radii of the first, second, third and fourth detection ranges 102a, 102b, 102c, 102d may be equal or substantially equal.

The first detection range 102a may have any suitable shape, and the shape may be dictated by the strength of the magnetic forces between the dispaceable magnetic element and the biasing magnet as well as the relative distance between the first target 32a and the magnetic element, for example. The detection range 100 can have a spherical shape with a center point disposed along the longitudinal axis 95a of the first detection member 28a. More specifically, the center point of the first detection range 102a may be disposed at or adjacent to a portion of a magnetic switch disposed at or adjacent to the first end 96 of the first detection member 28a. Accordingly, when viewed from a direction along the longitudinal axis 95a of the first detection member 28a (i.e., a direction parallel to the Y-axis of the of the reference coordinate system of FIG. 2), the first detection range 102a may have a circular shape, and the diameter of the circle may depend on several factors, such as the distance (along the Y-axis) of the first target 32a from the first end 96 of the first detection member 28a.

As illustrated in FIG. 2, the valve target assembly 10 includes the target shaft 12 extending along the target longitudinal axis 14. The target shaft 12 extends along the target longitudinal axis 14 from the first end 16 to the longitudinally-opposite second end 18. A portion (i.e., a first target shaft portion 104) of the target shaft 12 may be received through the lid bore 76 of the lid portion 62 of the enclosure 22 and a portion (i.e., a second target shaft portion 106) of the target shaft 12 may be received through the base bore 90 of the base portion 64 of the enclosure 22. Accordingly, an intermediate portion (i.e., an intermediate target shaft portion 108) of the target shaft 12 may be disposed within the interior portion 26 of the enclosure 22. The first target shaft portion 104 may be disposed at or adjacent to the second end 18 of the target shaft 12. The first end 16 of the target shaft 12 may be coupled to the valve shaft 19 that is coupled to a flow control element 20 such that a rotation of the valve shaft 19 about the valve longitudinal axis 46 results in a corresponding rotation of the target shaft 12 about the target longitudinal axis 14. Specifically, the first end 16 of the target shaft 12 may be directly or indirectly coupled to the second end 49 of the valve shaft 19 in any suitable manner. For example, the first end 16 of the target shaft 12 may be integrally formed with the second end 49 of the valve shaft 19 or the first end 16 of the target shaft 12 may be secured to the second end 49 of the valve shaft 19 by a collar (not shown). The valve longitudinal axis 46 and the target longitudinal axis 14 may be coaxially aligned, offset, or disposed at an oblique angle. The second end 18 of the target shaft 12 target shaft 12 may extend out of the lid bore 76 and beyond the top wall 70 of the lid portion 62 of the enclosure 22. The target shaft 12 may have any suitable cross-sectional shape or combination of shapes, such as a circular cross-sectional shape.

As illustrated in FIGS. 1, 2, 4A, and 4B, the valve target assembly 10 includes the target support 30 coupled to the valve shaft 12. The target support 30 may be coupled to a portion of the valve shaft 12 that is exterior to the interior portion 26 of the enclosure 22. For example, the target support 30 may be coupled to a portion of the valve shaft 12 that is exterior to the interior portion 26 of the enclosure 22. More specifically, the target support 30 may be coupled to an external portion 110 of the valve shaft 12 that extends out of the lid bore 76 and beyond (i.e., external to the enclosure 22 along the Y-axis) the top wall 70 of the lid portion 62 of the enclosure 22, and the external portion 110 may be disposed at or adjacent to the second end 18 of the target shaft 12.

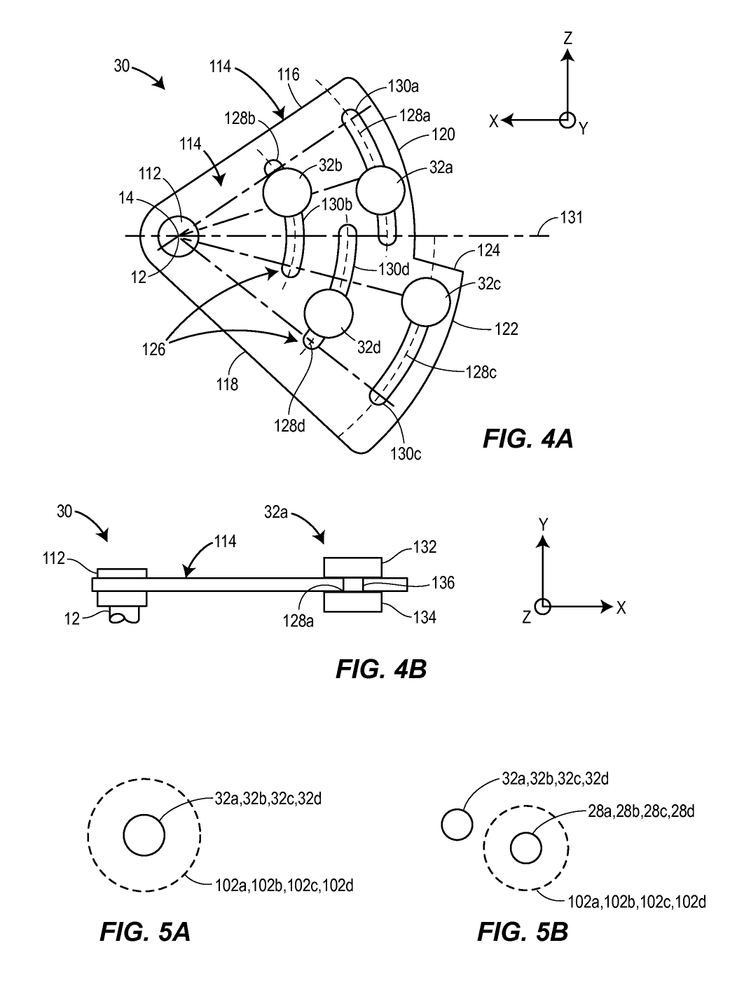

As illustrated in FIGS. 4A and 4B, the target support 30 may include a coupling portion 112 and an extension portion 114. The coupling portion 112 may secure the target support 30 to the target shaft 12, and the extension portion 114 may be coupled to the coupling portion 112. In some embodiments, the extension portion 114 may be integrally formed with the coupling portion 112, and the coupling portion 112 may be a bore formed in the extension portion 114. In other embodiments, the coupling portion 112 may be one or more annular collars formed around the target shaft 12 and non-rotatably secured to the target shaft 12 such that the coupling portion 112 does not rotate relative to the target shaft 12 (or the extension portion 114). The coupling portion 112 may be secured to the target shaft 12 by a set screw or by any other suitable means.

The extension portion 114 may be elongated and rigid may be cantilevered from the coupling portion 112 to extend parallel to or substantially parallel to the X-Z plane of the reference coordinate system of FIG. 4A. The extension portion 114 may have any suitable shape or combination of shapes, and the cross-section of the extension portion 114 may have one or more portions that extend parallel to the X-axis of FIG. 4B and may have one or more portions that are curved, partially curved, or otherwise contoured. For example, the extension portion 114 may be planar and may extend parallel to the X-axis of FIG. 4B. As illustrated in FIG. 4A, the extension portion 114 may have a perimeter defined in part by a first lateral edge 116 and a second lateral edge 118. The first lateral edge 116 and the second lateral edge 118 may be linear and non-parallel, and the first lateral edge 116 and the second lateral edge 118 may form an angle between 90 degrees and 45 degrees. A first end edge 120 may extend from an end of the first lateral edge 116 and extend inwardly towards the second lateral edge 116. The first end edge 120 may extend to the second lateral edge 116 or an end of the first end edge 120 may not extend to the second lateral edge 116. The first end edge 120 may have the shape of a segment of a circle having a center point aligned with the target longitudinal axis 14. A second end edge 122 may extend from an end of the second lateral edge 118 and extend inwardly towards, but not to the first lateral edge 116. The first end edge 120 may extend to a point adjacent to the end of the first end edge 120, and a transition edge 124 may extend from the end of the first end edge 120 to an end of the second end edge 122. The transition edge 124 may extend along a reference line that intersects the target longitudinal axis 14. The second end edge 122 may have the shape of a segment of a circle having a center point aligned with the target longitudinal axis 14, and a radius of the circular segment of the second end edge 122 may be greater than a radius of the circular segment of the first end edge 120.

Still referring to FIG. 4A, the extension portion 114 may have a plurality of slots 126 that are adapted to receive a portion of a target (e.g., the first target 32a), and each of the plurality of slots 126 provides a predetermined path of motion for the target. The plurality of slots 126 may include any number of slots, such as a first slot 128a, a second slot 128b, a third slot 128c, and a fourth slot 128d. The first slot 128a may receive the first target 32a, the second slot 128b may receive the second target 32b, the third slot 128c may receive the third target 32c, and the fourth slot 128d may receive the fourth target 32d, for example. Each of the slots 128a-128d may have a curved center line 130a-130d having the shape of a segment of a circle having a center point aligned with the target longitudinal axis 14.

Each of the slots 126 may have any suitable length and width to provide a suitable predetermined path of motion for the corresponding target. For example, the first slot 128a may extend from a first end adjacent to the first lateral edge 116 to a second end disposed adjacent to a reference line 131 bisecting the extension portion 114, and the first slot 128a may extend along a first center line 130a having a first radius that is less than the radius of the first end edge 120. The second slot 128b may extend from a first end adjacent to the first lateral edge 116 to a second end disposed adjacent to the reference line 131, and the second slot 128b may extend along a second center line 130b having a second radius that is less than the first radius of the first center line 130a. The third slot 128c may extend from a first end adjacent to the transition edge 124 (and/or to the reference line 131) and a second end disposed adjacent to the second lateral edge 118. The third slot 128c may extend along a third center line 130a having a third radius that is greater than the first radius of the first center line 130a and less than the radius of the second end edge 122. The fourth slot 128d may extend from a first end adjacent to the reference line 131 and a second end disposed adjacent to the second lateral edge 118. The fourth slot 128d may extend along a fourth center line 130d having a fourth radius that is greater than the second radius of the second center line 130b and less than the first radius of the first center line 130a. The extension portion 114 may also include surface indicia that may assist in positioning the first target 32a (or any target) at a desired location on the extension portion 114, and the surface indicia may be a plurality of lines that extend radially outward from the target longitudinal axis 14. The extension portion 114 may be made from any suitable material, such as a non-magnetic material, a non-ferrous material, and/or any material in which a significant magnetic field will not be induced when exposed to an exterior magnetic field (e.g., plastic or aluminum).

As illustrated in FIGS. 4A and 4B, the valve target assembly 10 may include at least one target, such as the first target 32a. The first target 32a may have any suitable size and shape or be made of any suitable material to allow it to be detected by the first detection member 28a when it is at least partially located within the first detection range 102a of the first detection member 28a. For example, the first target 32a may include an upper portion 132 and a lower portion 134, and an intermediate portion 136 may extend from a bottom portion of the upper portion 132 to a top portion of the lower portion 134. The intermediate portion 136 may be sized to fit within one or more of the plurality of slots 126, such as the first slot 128a. The lower portion 134 may have a cylindrical shape and may be made from a magnetic material of a ferrous material. The upper portion 132 may have a cylindrical shape that is adapted to be grasped by a technician to move the first target 32a relative to the target support 30, such as along the first slot 128a. The first target 32a may include a locking mechanism, (e.g., a threaded lock) that releasably secures the first target 32a to the extension portion 114 of the target support 30.

In operation, a technician may initially position the first target 32a on the extension portion 114 such that the first target 32a is positioned within the first detection range 102a when the target shaft 12 is in a first shaft position. The first shaft position may correspond to a closed position of the flow control element 20, for example. The technician may initially position the second target 32b on the extension portion 114 such that the second target 32b is positioned within the second detection range 102b when the target shaft 12 is in a second shaft position that is rotationally offset from the first shaft position. In the second shaft position, the first target 32a may be positioned outside the first detection range 102a. The second shaft position may correspond to a first partially open position of the flow control element 20, for example. The technician may initially position the third target 32c on the extension portion 114 such that the third target 32c is positioned within the third detection range 102c when the target shaft 12 is in a third shaft position that is rotationally offset from the first shaft position and the second shaft position. In the third shaft position, the first target 32a may be positioned outside the first detection range 102a and the second target 32b may be positioned outside the second detection range 102b. The third shaft position may correspond to a second partially open position of the flow control element 20, for example. The technician may initially position the fourth target 32d on the extension portion 114 such that the fourth target 32d is positioned within the fourth detection range 102d when the target shaft 12 is in a fourth shaft position that is rotationally offset from the first shaft position, the second shaft position, and the third shaft position. In the fourth shaft position, the first target 32a, the second target 32b, and the third target 32c may each be positioned outside the first detection range 102a, the second detection range 102b, and the third detection range 102c, respectively. The fourth shaft position may correspond to a fully open position of the flow control element 20, for example.

To reposition any of the first, second, third, or fourth targets 32a-32d, the technician may first disengage a locking mechanism (if necessary) and slide the target along the respective slot 128a-128d to a desired position on the extension portion 114. Such an operation may be necessary to align the first, second, third, or fourth targets 32a-32d with a different detection member (e.g., a fifth detection member 28e, not shown) to identify a fifth shaft position that may correspond to a third partially open position of the flow control element 20, for example. So configured, the technician may reposition any or all of the first, second, third, or fourth targets 32a-32d without having to open the enclosure 22, thereby minimizing maintenance time and reducing the likelihood that the enclosure will not properly seal when reassembled.

While various embodiments have been described above, this disclosure is not intended to be limited thereto. Variations can be made to the disclosed embodiments that are still within the scope of the appended claims.

What is claimed is:

1. A valve target assembly adapted to be used in a control valve assembly, the valve target assembly comprising:
a target shaft extending along a target longitudinal axis, the target shaft having a first end and a longitudinally-opposite second end, wherein the first end of the target shaft is adapted to be coupled to a valve shaft that is coupled to a flow control element;
an enclosure having a plurality of walls that cooperate to define a sealed interior portion, wherein a portion of the target shaft is disposed within the interior portion of the enclosure;
a first detection member disposed with the interior portion of the enclosure;
a target support coupled to the target shaft, wherein the target support is disposed outside of the interior portion of the enclosure; and
a first target coupled to the target support,
wherein in a first shaft position, the first target is adapted to be within a detection range of the first detection member, and in a second shaft position rotationally offset from the first shaft position, the first target is adapted to be outside of the detection range of the first detection member.

2. The valve target assembly of claim 1, further comprising:
a second detection member disposed with the interior portion of the enclosure;
a second target removably coupled to the target support,
wherein in a third shaft position, the second target is adapted to be within a detection range of the second detection member, and in a fourth shaft position rotationally offset from the second shaft position, the second target is adapted to be outside of the detection range of the second detection member.

3. The valve target assembly of claim 2, wherein the first shaft position is the same as the third shaft position, and the second shaft position is the same as the fourth shaft position.

4. The valve target assembly of claim 2, wherein the first shaft position is the same as the fourth shaft position, and the second shaft position is the same as the third shaft position.

5. The valve target assembly of claim 1, wherein one of the plurality of walls of the enclosure is disposed between the first detection member and the first target.

6. The valve target assembly of claim 1, wherein the one of the plurality of walls of the enclosure is non-magnetic.

7. The valve target assembly of claim 1, wherein the first target includes an upper portion and a lower portion, and wherein a portion of the target support is disposed between the upper portion and the lower portion.

8. The valve target assembly of claim 7, wherein at least one of the upper portion and the lower portion includes a magnet.

9. The valve target assembly of claim 1, wherein the target support includes a planar attachment portion.

10. The valve target assembly of claim 9, wherein the attachment portion includes a first adjustment slot that extends at least partially along a circular reference line having a center point along the longitudinal axis.

11. The valve target assembly of claim 1, wherein the first detection member is a magnetically-actuated proximity switch.

12. The valve target assembly of claim 1, wherein the target support is coupled to the target shaft at or adjacent to the second end of the target shaft.

13. The valve target assembly of claim 1, wherein the first target is at least one of removably coupled to the target support or displaceably coupled to the target support.

14. The valve target assembly of claim 1, wherein the target longitudinal axis is coaxially aligned with a longitudinal shaft axis of the valve shaft.

15. The valve target assembly of claim 1, wherein the valve shaft has a first end and a second end, and the first end of the valve shaft is coupled to the flow control element and the second end of the valve shaft is integrally formed with the second end of the target shaft.

16. A control valve assembly comprising:
a valve shaft extending along a longitudinal axis, the valve shaft having a first end and a longitudinally-opposite second end;
a flow control element coupled to a first portion of the valve shaft;
a valve body having an inlet, an outlet, and a valve seat disposed between the inlet and the outlet;
a valve actuator coupled to the valve shaft, the valve actuator adapted to rotate the valve shaft about the longitudinal axis such that the flow control element rotates from a closed position in which the flow control element sealingly engages the valve seat to an open position in which the flow control element is disengaged from the valve seat;
an enclosure coupled to the valve body, the enclosure having a plurality of walls that cooperate to define a sealed interior portion, wherein a second portion of the valve shaft is disposed within the interior portion of the enclosure;
a first detection member disposed with the interior portion of the enclosure;
a target support coupled to a third portion of the valve shaft, wherein the target support is disposed outside of the interior portion of the enclosure; and
a first target coupled to the target support,
wherein in a first shaft position, the first target is adapted to be within a detection range of the first detection member, and in a second shaft position rotationally offset from the first shaft position, the first target is adapted to be outside of the detection range of the first detection member.

17. The control valve assembly of claim 16, wherein the first shaft position corresponds to the closed position and the second shaft position corresponds to the open position.
